(19) United States
(12) Patent Application Publication
(10) Pub. No.: US 2006/0097975 A1
(43) Pub. Date: May 11, 2006

(54) Display device including sensing elements

(75) Inventors: Joo-Hyung Lee, Gyeonggi-do (KR); Kee-Han Uh, Gyeonggi-do (KR); Hyung-Guel Kim, Gyeonggi-do (KR)

Correspondence Address: David W. Heid;MacPHERSON KWOK CHEN & HEID LLP, Suite 226, 1762 Technology Drive, San Jose, CA, 95110, US

(73) Assignee: Samsung Electronics Co., Ltd., Suwon-si (KR)

(21) Appl. No.: 11/270,151

(22) Filed: Nov. 8, 2005

(30) Foreign Application Priority Data
Nov. 8, 2004 (KR) 10-2004-0090376

(51) Int. Cl. G09G 3/36

(52) U.S. Cl. 345/98

(57) ABSTRACT

A display device is provided, which includes: a display panel unit; a first sensor formed on the display panel unit and generating a first sensing signal based on an external light; and a second sensor formed on the display panel unit and generating a second sensing signal in response to a touch.

### BACKGROUND

(a) Field of the Invention

The present invention relates to a display device including sensing elements and a driving method thereof.

(b) Description of Related Art

A liquid crystal display (LCD) includes a pair of panels provided with pixel electrodes and a common electrode and a liquid crystal layer with dielectric anisotropy interposed between the panels. The pixel electrodes are arranged in a matrix and are connected to switching elements such as thin film transistors (TFTs) such that the pixel electrodes receive image data voltages row by row. The common electrode covers the entire surface of one of the two panels and is supplied with a common voltage. A pixel electrode, corresponding portions of the common electrode, and corresponding portions of the liquid crystal layer form a liquid crystal capacitor. The liquid crystal capacitor and a switching element connected thereto form basic elements of a pixel.

An LCD generates electric fields by applying voltages to pixel electrodes and a common electrode and varies the strength of the electric fields to adjust the transmittance of light passing through a liquid crystal layer, thereby displaying images.

A touch screen panel is an apparatus on which a finger or a stylus is touched to write characters, to draw pictures, or to instruct a device such as a computer to execute instructions by using icons. The touch screen panel has its own mechanism to determine whether and where a touch exists. The touch screen panel is typically attached on a display device such as an LCD. However, an LCD provided with a touch screen panel has a high manufacturing cost due to the cost of the touch screen panel, low productivity due to the additional step for attaching the touch screen panel to the LCD, reduction of the luminance of the LCD, increase of the thickness of the LCD, etc.

Photosensors including thin film transistors have been incorporated into pixels in an LCD instead of a touch screen panel. A photosensor senses the variation of light incident on a region of the display to inform the LCD whether a user's finger or other structure is touching the screen and where the touch is applied.

However, the characteristics of a photosensor depend on environmental factors such as strength of external light, strength of backlight lamps, temperature, etc. As a result, there may be many errors in the light sensing function caused by these factors such that the photosensor informs of the presence of a touch that is not actually present or it fails to inform the presence of an actual touch.

### SUMMARY

A display device is provided, which includes: a display panel unit; a first sensor formed on the display panel unit and generating a first sensing signal based on an external light; and a second sensor formed on the display panel unit and generating a second sensing signal in response to a touch.

The first sensor may include a switch connectable to a predetermined voltage in response to the touch, and particularly in response to the pressure of the touch.

The switch may include a first electrode and a second electrode spaced apart from the first electrode and connected to the predetermined voltage, and the second electrode and the first electrode form an electrical connection in response to a pressure applied to the second sensor.

The display panel unit may include a first panel and a second panel facing the first panel and spaced apart from the first panel, wherein a distance between the first panel and the second panel may be varied by a pressure exerted on the second panel.

The first sensor may include a first sensing electrode disposed on the first panel and a second sensing electrode disposed on the second panel.

The display panel unit may further include a liquid crystal layer disposed between the first panel and the second panel.

The display panel unit may further include a first display electrode disposed on the first panel and a second display electrode disposed on the second panel.

The second sensing electrode and the second display electrode may be connected to each other and may form a continuous plane.

A distance between the first sensing electrode and the second sensing electrode may be less than a distance between the first display electrode and the second display electrode.

The second sensing electrode and the first sensing electrode may form an electrical connection in response to a pressure exerted thereon.

The second panel may further comprise a rising disposed under the second sensing electrode and facing the first display electrode.

The distance between the first sensing electrode and the second sensing electrode may be from about 0.1 microns to about 1.0 microns.

The display panel unit may further include a spacer disposed between the first panel and the second panel.

A display device for detecting a touch according to another embodiment of the present invention includes: a display panel on which a touch is exerted; a first sensor formed on the display panel and sensing a first physical quantity; and a second sensor formed on the display panel and sensing a second physical quantity different from the first physical quantity, wherein the touch varies the first and the second physical quantities.

The variation of the first physical quantity caused by the touch may range over a wider area than the variation of the second physical quantity caused by the touch.

The second physical quantity may include luminance of light and the first physical quantity may include pressure.

The first sensor may include a switch generating a bistate output signal in response to the variation of the second physical quantity, and the second sensor may generate an indication signal having a magnitude that depends on a magnitude of the second physical quantity.

The second physical quantity may be more sensitive than the first physical quantity to a stimulus other than a touch.

A display device according to an embodiment of the present invention includes: a display panel unit; a plurality of first sensors formed on the display panel unit and generating first sensing signals based on an external light; and a plurality of second sensors formed on the display panel unit and generating second sensing signals in response to a touch.

Each of the second sensors may include a switch connectable to a predetermined voltage in response to the touch, preferably to pressure exerted by the touch.

The second sensor may include a first electrode and a second electrode spaced apart from the first electrode and connected to the predetermined voltage, and the second electrode and the first electrode may be contactable in response to a pressure exerted thereon.

The second sensors may have a resolution less than a resolution of the first sensors.

The display device may further include a plurality of pixels displaying images, wherein the resolution of the first sensors is about one quarter of a resolution of the pixels.

At least two of the second sensors may have commonly connected outputs and may simultaneously output the second sensing signals.

The display device may further include: a plurality of first sensor data lines connected to outputs of the first sensors; a plurality of second sensor data lines connected to outputs of the second sensors and arranged alternately with the first sensor data lines; a plurality of sensor scanning lines connected to the second sensor units and transmitting signals that make the second sensors output the second sensing signals.

At least two of the second sensor data lines or at least two of the sensor scanning lines may be connected to each other.

The display device may further include a plurality of pixels formed on the display panel for displaying images.

The pixels may be supplied with a common voltage and the second sensors may be supplied with the common voltage in response to the touch.

The common voltage may swing between first and second levels and the first and the second sensors may output the second sensing signals when the common voltage has the first level.

The first sensors and the second sensors may be disposed outsides of the pixels.

### BRIEF DESCRIPTION OF THE DRAWINGS

The present invention will become more apparent in light of the embodiments described in detail below with reference to the accompanying drawings in which:

FIG. 1 is a block diagram of an LCD according to an embodiment of the present invention;

FIG. 2 is an equivalent circuit diagram of a pixel of an LCD according to an embodiment of the present invention;

FIG. 3 is an equivalent circuit diagram of a pixel including a photo sensing unit of an LCD according to an embodiment of the present invention;

FIG. 4 is an equivalent circuit diagram of a pixel including a pressure sensing unit of an LCD according to an embodiment of the present invention;

FIGS. 5A and 5B are exemplary schematic sectional views of the panel assembly shown in FIG. 1 including pressure sensing units without and with a touch;

FIG. 6 illustrates an arrangement of pixels and sensing units of an LCD according to an embodiment of the present invention;

FIG. 7 illustrates an arrangement of pixels and sensing units of an LCD according to another embodiment of the present invention; and

FIG. 8 illustrates exemplary waveforms of a common voltage and scanning signals according to an embodiment of the present invention.

### DETAILED DESCRIPTION OF THE PREFERRED EMBODIMENTS

The present invention is described below with reference to the accompanying drawings, in which preferred embodiments of the invention are shown.

In the drawings, the thickness of layers and regions are exaggerated for clarity. Like numerals refer to like elements throughout. It will be understood that when an element such as a layer, region or substrate is referred to as being “on” another element, it can be directly on the other element or intervening elements may also be present. In contrast, when an element is referred to as being “directly on” another element, there are no intervening elements present.

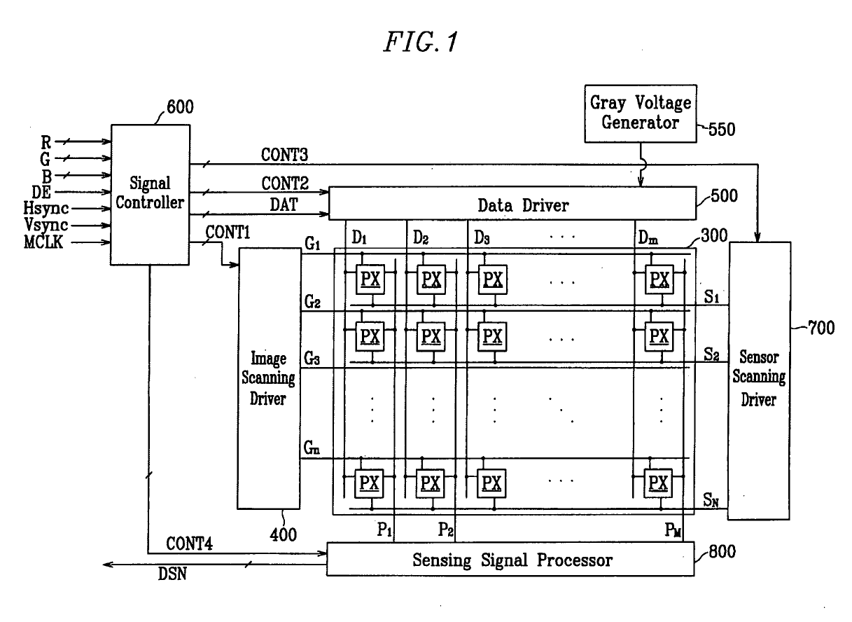

A liquid crystal display according to an embodiment of the present invention now will be described in detail with reference to FIGS. 1, 2, 3 and 4.

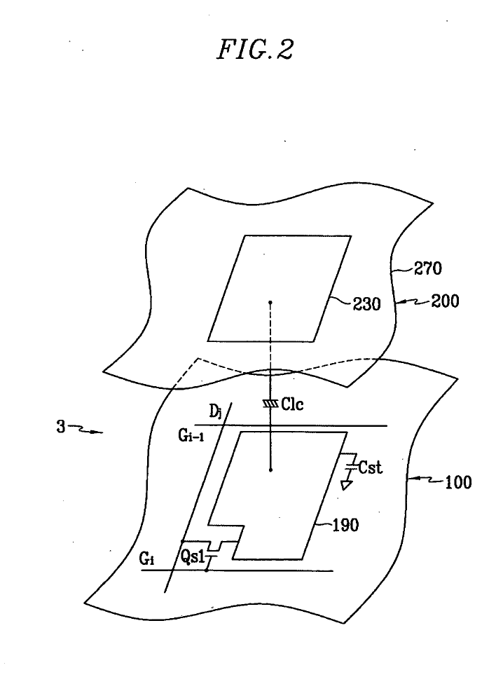

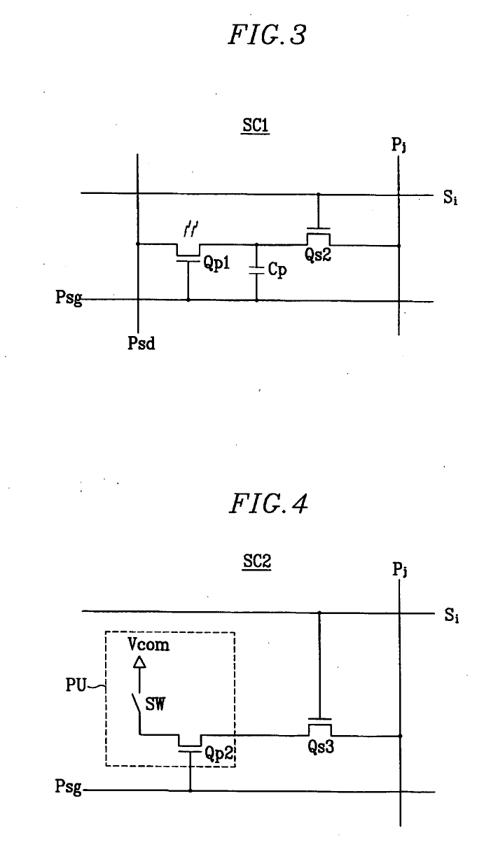

FIG. 1 is a block diagram of an LCD according to an embodiment of the present invention, FIG. 2 is an equivalent circuit diagram of a pixel of an LCD according to an embodiment of the present invention, FIG. 3 is an equivalent circuit diagram of a pixel including a photo sensing unit of an LCD according to an embodiment of the present invention, and FIG. 4 is an equivalent circuit diagram of a pixel including a pressure sensing unit of an LCD according to an embodiment of the present invention.

Referring to FIG. 1, an LCD according to an embodiment includes a liquid crystal (LC) panel assembly 300. The LCD further includes an image scanning driver 400, an image data driver 500, a sensor scanning driver 700, and a sensing signal processor 800 coupled with the panel assembly 300, a gray voltage generator 550 coupled with the image data driver 500, and a signal controller 600 controlling the above elements.

Referring to FIGS. 1-4, the panel assembly 300 includes a plurality of display signal lines G₁-Gₙ and D₁-Dₘ, a plurality of sensor signal lines S₁-S_{N}, P₁-P_{M}, Psg and Psd, a plurality of pixels PX connected to the display signal lines G₁-Gₙ and D₁-Dₘ and arranged substantially in a matrix, and a plurality of sensing units SC1 and SC2 connected to the sensor signal lines S₁-S_{N}, P₁-P_{M}, Psg, and Psd and arranged substantially in a matrix. In a structural view shown in FIG. 2, the panel assembly 300 includes a lower panel 100 and an upper panel 200 facing each other and a liquid crystal (LC) layer 3 interposed between the lower panel 100 and the upper panel 200.

The display signal lines include a plurality of image scanning lines G₁-Gₙ transmitting image scanning signals and a plurality of image data lines D₁-Dₘ transmitting image data signals.

The sensor signal lines include a plurality of a plurality of sensor scanning lines S₁-S_{N} transmitting sensor scanning signals, a plurality of sensor data lines P₁-P_{M} transmitting sensor data signals, a plurality of control voltage lines Psg transmitting a sensor control voltage, and a plurality of input voltage lines Psd transmitting a sensor input voltage.

The image scanning lines G₁-Gₙ and the sensor scanning lines S₁-S_{N} extend substantially in a row direction and are substantially parallel to each other, while the image data lines D₁-Dₘ and the sensor data lines P₁-P_{M} extend substantially in a column direction and are substantially parallel to each other.

Referring to FIG. 2, each pixel PX, for example, a pixel in the i-th row (i=1, 2, . . . , n) and the j-th column (j=1, 2, . . . , m) includes a switching element Qs1 connected to an image scanning line Gᵢ and an image data line Dⱼ. In addition, the pixel PX includes a LC capacitor Clc and a storage capacitor Cst that are connected to the switching element Qs1. In some embodiments, the storage capacitor Cst may be omitted.

The switching element Qs1 is disposed on the lower panel 100 and has three terminals, a control terminal connected to the image scanning line Gᵢ, an input terminal connected to the image data line Dⱼ, and an output terminal connected to the LC capacitor Clc and the storage capacitor Cst.

The LC capacitor Clc includes a pixel electrode 190 disposed on the lower panel 100 and a common electrode 270 disposed on the upper panel 200 which function as the two terminals for the capacitor Clc. The LC layer 3 disposed between the two electrodes 190 and 270 functions as a dielectric for the LC capacitor Clc. The pixel electrode 190 is connected to the switching element Qs1, and the common electrode 270 is supplied with a common voltage Vcom and covers an entire surface of the upper panel 200. In other embodiments, the common electrode 270 may be provided on the lower panel 100, and at least one of the electrodes 190 and 270 may be shaped like a bar or stripe.

The storage capacitor Cst functions as an auxiliary capacitor for the LC capacitor Clc. The storage capacitor Cst includes the pixel electrode 190 and a separate signal line, which is provided on the lower panel 100. The separate signal line overlaps the pixel electrode 190 via an insulator and is supplied with a predetermined voltage, such as the common voltage Vcom. Alternatively, the storage capacitor Cst includes the pixel electrode 190 and an adjacent gate line (referred to as the previous gate line) which overlaps the pixel electrode 190 via an insulator.

For color displays, each pixel uniquely represents a primary color (i.e., spatial division) or each pixel sequentially represents one of multiple primary colors in turn (i.e., temporal division) such that spatial or temporal sum of the primary colors are recognized as a desired color. An example of a set of the primary colors includes red, green, and blue. FIG. 2 shows an example of the spatial division type of color display in which each pixel includes a color filter 230 representing one of the primary colors. The color filter 230 is provided in an area of the upper panel 200 facing the pixel electrode 190. Alternatively, the color filter 230 is provided on or under the pixel electrode 190 on the lower panel 100.

One or more polarizers (not shown) are attached to at least one of the panels 100 and 200. In addition, one or more retardation films (not shown) for compensating refractive anisotropy may be disposed between the polarizer(s) and the panel(s).

The sensing units include a plurality of photo sensing units SC1 and a plurality of pressure sensing units SC2, which are exclusively disposed such that the photo sensing units SC1 and the pressure sensing units SC2 are not disposed in the same location. The sensing units may be included in the pixels, disposed between the pixels, or disposed in a separately provided area.

Each of the photo sensing units SC1 shown in FIG. 3 includes a photo sensing element Qp1 connected to a control voltage line Psg and an input voltage line Psd, a sensor capacitor Cp connected to the photo sensing element Qp1, and a switching element Qs2 connected to a sensor scanning line Sᵢ, the photo sensing element Qp1, and a sensor data line Pⱼ.

The photo sensing element Qp1 has three terminals: a control terminal connected to the control voltage line Psg to be biased by the sensor control voltage, an input terminal connected to the input voltage line Psd to be biased by the sensor input voltage, and an output terminal connected to the switching element Qs2. The photo sensing element Qp1 comprises a photoelectric material that generates a photocurrent upon exposure to light. An example of the photo sensing element Qp1 is a thin film transistor having an amorphous silicon or polysilicon channel that generates a photocurrent. The sensor control voltage applied to the control terminal of the photo sensing element Qp1 is sufficiently low or sufficiently high to keep the photo sensing element Qp1 in an off state without incident light. The sensor input voltage applied to the input terminal of the photo sensing element Qp1 is sufficiently high or sufficiently low to maintain the photocurrent flow. The sensor input voltage causes the photocurrent to flow toward the switching element Qs2. In addition, the photocurrent also flows into the sensor capacitor Cp to charge the sensor capacitor Cp.

The sensor capacitor Cp is connected between the control terminal and the output terminal of the photo sensing element Qp1. The sensor capacitor Cp stores electrical charges output from the photo sensing element Qp1 to maintain a predetermined voltage. In other embodiments, the sensor capacitor Cp may be omitted.

The switching element Qs2 also has three terminals: a control terminal connected to the sensor scanning line S1, an input terminal connected to the output terminal of the photo sensing element Qp1, and an output terminal connected to the sensor data line Pⱼ. The switching element Qs2 outputs a sensor output signal to the sensor data line Pⱼ in response to the sensor scanning signal from the sensor scanning line Sᵢ. The sensor output signal from the switching element Qs2 is the sensing current from the photo sensing element Qp1 or a current driven by the voltage stored in the sensor capacitor Cp.

Each of the pressure sensing units SC2 shown in FIG. 4 includes a pressure sensing element PU connected to the common voltage Vcom and a control voltage line Psg, and a switching element Qs3 connected to a sensor scanning line Sᵢ, the pressure sensing element PU, and a sensor data line Pⱼ.

The pressure sensing element PU includes a pressure switch SW connected to the common voltage Vcom and a driving transistor Qp2 connected between the switch SW and the switching element Qs3.

The pressure applied to the pressure switch SW caused by a touch exerted on the panel assembly 300 causes the pressure switch SW to connect the driving transistor Qp2 to the common voltage Vcom. For example, the pressure may make an electrode (not shown) supplied with the common voltage Vcom approach a terminal of the driving transistor Qp2 to be in contact therewith. Alternatively, the switch SW may use another physical mechanism for connecting the driving transistor Qp2 to the common voltage Vcom.

The driving transistor Qp2 has three terminals: a control terminal connected to the control voltage line Psg to be biased by the sensor control voltage, an input terminal connected to the switch SW, and an output terminal connected to the switching element Qs3. The driving transistor Qp2 generates and outputs an electrical current upon receipt of the common voltage Vcom from the switch SW.

The switching element Qs3 also has three terminals: a control terminal connected to the sensor scanning line Sᵢ, an input terminal connected to the output terminal of the driving transistor Qp2, and an output terminal connected to the sensor data line Pⱼ. The switching element Qs3 outputs the current from the driving transistor Qp2 to the sensor data line Pⱼ as a sensor output signal in response to the sensor scanning signal from the sensor scanning line Sᵢ.

The switching elements Qs1, Qs2, and Qs3, the photo sensing element Qp1, and the driving transistor Qp2 may comprise amorphous silicon or polysilicon thin film transistors (TFTs).

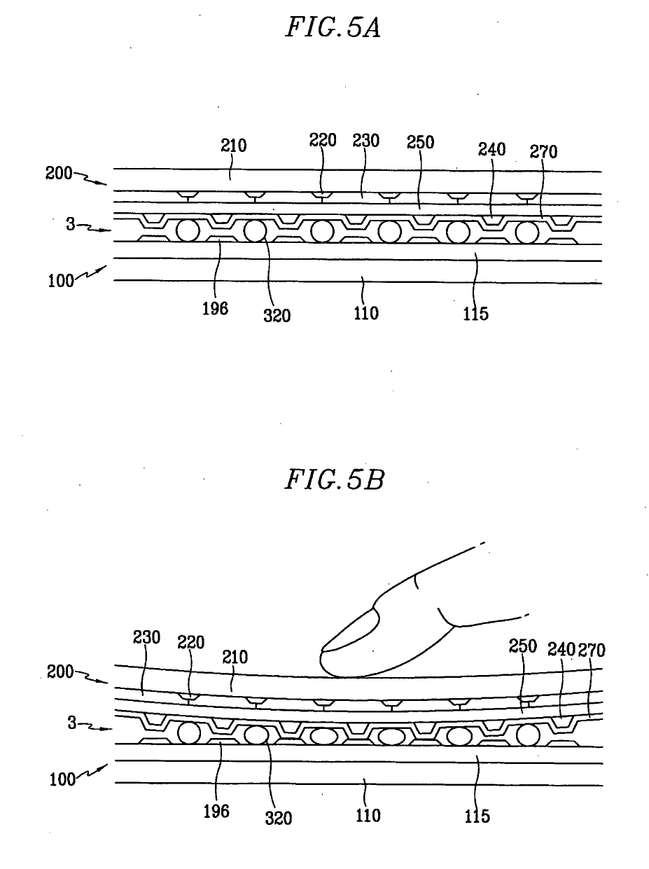

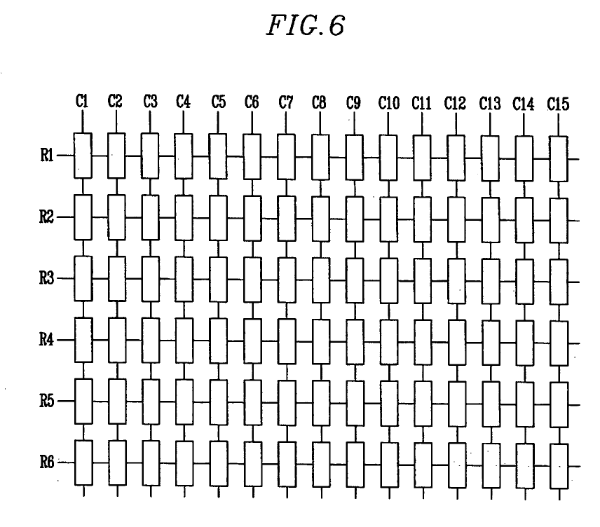

An exemplary structure and an operation of the pressure sensing unit are described below with reference to FIGS. 5A and 5B as well as FIGS. 1-4.

FIGS. 5A and 5B are exemplary schematic sectional views of the panel assembly shown in FIG. 1 including pressure sensing units. FIG. 5A shows the panel assembly in a default untouched state. FIG. 5B shows the state of the panel assembly when a user touches the display.

Referring to FIGS. 5A and 5B, a LC panel assembly 300 includes a lower panel 100 and an upper panel 200. The LC panel assembly 300 further includes a plurality of elastic spacers 320 and a LC layer 3 disposed between the panels 100 and 200.

Regarding the lower panel 100, pixel members 115 are disposed on an insulating substrate 110 comprising, e.g., transparent glass or plastic. The pixel members 115 include pixel electrodes (190 in FIG. 2), switching elements Qs1, photo sensing units SC1, and pressure sensing units SC2.

A plurality of switch electrodes 196, which are connected to input terminals of driving transistors Qp2 in the pressure sensing units SC2, are disposed on the pixel members 115. The switch electrodes 196 may form the input terminals of the driving transistors Qp2.

Regarding the upper panel 200, a light blocking member 220 (referred to as a black matrix) for preventing light leakage is formed on an insulating substrate 210 comprising, e.g., transparent glass or plastic. The light blocking member 220 defines a plurality of open areas facing the pixel electrodes 190.

A plurality of color filters 230 are also formed on the substrate 210. The color filters 230 are disposed substantially in the open areas enclosed by the light blocking member 220.

An overcoat 250 is formed on the color filters 230 and the light blocking member 220. The overcoat 250 preferably comprises an (organic) insulator and protects the color filters 230, prevents the color filters 230 from being exposed, and provides a flat lower surface for the upper panel 200.

A plurality of risings 240 are formed on the overcoat 250. The risings 240 preferably comprise an organic insulator and face the switch electrodes 196 on the lower panel 100.

A common electrode 270 is formed on the overcoat 250 and the risings 240. The common electrode 270 preferably comprises a transparent conductive material such as ITO (indium tin oxide) and IZO (indium zinc oxide) and is supplied with a common voltage Vcom. The common electrode 270 may include portions disposed between the risings 240 and the overcoat 250. This structure can be obtained by depositing a transparent conductor both before and after the formation of the risings 240. The thickness of the transparent conductor deposited after the formation of the risings 240 may be about 10-300 nm.

The spacers 320 separate the TFT array panel 100 and the common electrode panel 200 to form a gap therebetween. The spacers 320 may comprise spherical or ellipsoidal beads spread across the panel assembly 300. Alternatively, the spacers 320 may comprise columnar or rigid spacers arranged in a regular manner.

The LC layer 3 is filled in the gap between the panels 100 and 200 formed by the spacers 320. The LC layer 3 may be subjected to a homeotropic alignment or a homogeneous alignment. The thickness of the LC layer 3 between the switch electrodes 196 and the risings 240 may be equal to about 0.01-1.0 microns.

The switch electrodes 196 and portions of the common electrode 270 formed on the risings 240 form switches SW in the pressure sensing units SC2.

FIG. 5A shows the panel assembly 300 in a default untouched state. The panels 100 and 200 are separated by the spacers 320. Thus, the separation between the common electrode 270 and the switch electrodes 196 is kept constant.

FIG. 5B shows the panel assembly 300 when pressed by a user's finger. The spacers 320 are deformed by the pressure applied by the finger. Thus, the upper panel 200 approaches the lower panel 100 near the pressed point. Accordingly, the distance between the common electrode 270 and the switch electrodes 196 is reduced such that one or more of the switch electrodes 196 make contact with the common electrode 270. As a result, the common voltage Vcom is transmitted to the switch electrodes 196. Then, the driving transistors Qp2 corresponding to contacted switch electrodes 196 generate output currents.

The pressure sensing unit SC2 can effectively indicate the existence of a touch. However, the pressure sensing unit SC2 may not provide an accurate indication of the precise position of the touch since the region of the upper panel 200 making contact with the switch electrodes of the lower panel 100 caused by the touch may cover a wide area. In contrast, the photo sensing unit SC1 can provide an accurate indication of the precise position of a touch of an object by sensing the variation of light illuminance caused by a shadow of the object. However, the photo sensing unit SC1 may not effectively indicate the existence of the touch since the variation of illuminance can be generated by various causes other than a touch. For example, an object disposed near the panel assembly 300 which does not touch the panel assembly 300 may vary the illumination of light onto the photo sensing unit SC1. The combination of the photo sensing unit SC2 and the pressure sensing unit SC2 can provide an effective and accurate indication of the presence and position of a contact on the panel assembly 300.

In other embodiments, the above-described structures of the photo sensing unit SC1 and the pressure sensing unit SC2 may be replaced with sensing units that sense two physical quantities other than pressure and light. Sensing one of the two physical quantities may provide an effective indication of the existence of a touch, and sensing the other quantity may provide an accurate indication of the position of the touch. The touch may vary the former physical quantity in a wide region of the display, while the touch may vary the latter physical quantity in a narrow region of the display. The former physical quantity may not be easily varied by a stimulus other than a touch, while the latter physical quantity may be easily varied by a stimulus other than a touch. The sensing units for sensing the former physical quantity may include, e.g., a switch that turns on/off to generate a bistate output signal in response to a variation of the former physical quantity larger than a predetermined value. The sensing units for sensing the latter physical quantity may generate an indication signal having continuous or multiple values depending on the magnitude of the latter physical quantity.

Referring back to FIG. 1, the gray voltage generator 550 generates two sets of a plurality of gray voltages related to the transmittance of the pixels. The gray voltages in one set have a positive polarity with respect to the common voltage Vcom, while those in the other set have a negative polarity with respect to the common voltage Vcom.

The image scanning driver 400 is connected to the image scanning lines G₁-Gₙ of the panel assembly 300 and synthesizes a gate-on voltage Von and a gate-off voltage Voff to generate the image scanning signals for application to the image scanning lines G₁-Gₙ.

The image data driver 500 is connected to the image data lines D₁-Dₘ of the panel assembly 300 and applies image data signals, which are selected from the gray voltages supplied from the gray voltage generator 550, to the image data lines D₁-Dₘ.

The sensor scanning driver 700 is connected to the sensor scanning lines S₁-S_{N} of the panel assembly 300 and synthesizes a gate-on voltage Von and a gate-off voltage Voff to generate the sensor scanning signals for application to the sensor scanning lines S₁-Sₙ.

The sensing signal processor 800 is connected to the sensor data lines P₁-P_{M} of the display panel 300 and receives the sensor data signals from the sensor data lines P₁-P_{M}. The sensing signal processor 800 converts the analog sensor data signals from the sensor data lines P₁-P_{M} into digital signals to generate digital sensor data signals DSN. The sensor data signals carried by the sensor data lines P₁-P_{M} may comprise current signals and in this case, the sensing signal processor 800 converts the current signals into voltage signals before the analog-to-digital conversion. One sensor data signal carried by one sensor data line P₁-P_{M} at a time may include one sensor output signal from one switching element Qs2 or may include at least two sensor output signals outputted from at least two switching elements Qs2.

The signal controller 600 controls the image scanning driver 400, the image data driver 500, the sensor scanning driver 700, and the sensing signal processor 800.

Each of the processing units 400, 500, 600, 700, and 800 may comprise at least one integrated circuit (IC) chip mounted on the LC panel assembly 300 or on a flexible printed circuit (FPC) film in a tape carrier package (TCP) type, which are attached to the panel assembly 300. Alternately, at least one of the processing units 400, 500, 600, 700, and 800 may be integrated into the panel assembly 300 along with the signal lines G₁-Gₙ, D₁-Dₘ, S₁-S_{N}, P₁-P_{M}, Psg, and Psd, the switching elements Qs1, Qs2 and Qs3, and the photo sensing elements Qp1. Alternatively, all the processing units 400, 500, 600, 700, and 800 may be integrated into a single IC chip, but at least one of the processing units 400, 500, 600, 700 and 800 or at least one circuit element in at least one of the processing units 400, 500, 600, 700, and 800 may be disposed out of the single IC chip.

The operation of the above-described LCD will be described in detail below.

The signal controller 600 is supplied with input image signals R, G, and B and input control signals for controlling the display from an external graphics controller (not shown). The input control signals include a vertical synchronization signal Vsync, a horizontal synchronization signal Hsync, a main clock MCLK, and a data enable signal DE.

On the basis of the input control signals and the input image signals R, G, and B, the signal controller 600 generates image scanning control signals CONT1, image data control signals CONT2, sensor scanning control signals CONT3, and sensor data control signals CONT4. In addition, the signal controller 600 processes the image signals R, G, and B to control the operation of the display panel 300. The signal controller 600 sends the scanning control signals CONT1 to the image scanning driver 400, the processed image signals DAT and the data control signals CONT2 to the data driver 500, the sensor scanning control signals CONT3 to the sensor scanning driver 700, and the sensor data control signals CONT4 to the sensing signal processor 800.

The image scanning control signals CONT1 include an image scanning start signal STV for instructing the image scanning driver 400 to start image scanning and at least one clock signal for controlling the output time of the gate-on voltage Von. The image scanning control signals CONT1 may include an output enable signal OE for defining the duration of the gate-on voltage Von.

The image data control signals CONT2 include a horizontal synchronization start signal STH for indicating that start of image data transmission for a group of pixels PX, a load signal LOAD for controlling the application of the image data signals to the image data lines D₁-Dₘ, and a data clock signal HCLK. The image data control signal CONT2 may further include an inversion signal RVS for reversing the polarity of the image data signals with respect to the common voltage Vcom.

Responsive to the image data control signals CONT2 from the signal controller 600, the data driver 500 receives a packet of the digital image signals DAT for the group of pixels PX from the signal controller 600, converts the digital image signals DAT into analog image data signals selected from the gray voltages supplied by the gray voltage generator 550, and applies the analog image data signals to the image data lines D₁-Dₘ.

The image scanning driver 400 applies the gate-on voltage Von to an image scanning line G₁-Gₙ in response to the image scanning control signals CONT1 from the signal controller 600, thereby turning on the switching transistors Qs1 connected thereto. The image data signals applied to the image data lines D₁-Dₘ are then supplied to the pixels PX through the activated switching transistors Qs1.

The difference between the voltage of an image data signal and the common voltage Vcom is represented as a voltage across the LC capacitor Clc, which is referred to as a pixel voltage. The LC molecules in the LC capacitor Clc have orientations controlled by the magnitude of the pixel voltage, and the molecular orientations determine the polarization of light passing through the LC layer 3. The polarizer(s) converts the light polarization into the light transmittance to display images.

By repeating this procedure by a unit of a horizontal period (also referred to as “1H” and equal to one period of the horizontal synchronization signal Hsync and the data enable signal DE), all image scanning lines G₁-Gₙ are sequentially supplied with the gate-on voltage Von, thereby applying the image data signals to all pixels PX to display an image for a frame.

When the next frame starts after one frame finishes, the inversion control signal RVS applied to the data driver 500 is controlled such that the polarity of the image data signals is reversed (which is referred to as “frame inversion”). The inversion control signal RVS may be also controlled such that the polarity of the image data signals flowing in a data line are periodically reversed during a single frame (for example, row inversion and dot inversion), or the polarity of the image data signals in one packet are reversed (for example, column inversion and dot inversion).

In the meantime, the sensor scanning driver 700 applies the gate-off voltage to the sensor scanning lines S₁-S_{M} to turn on the switching elements Qs2 and Qs3 connected thereto in response to the sensing control signals CONT3. Then, the switching elements Qs2 and Qs3 output sensor output signals to the sensor data lines P₁-P_{M} to form sensor data signals, and the sensor data signals are received by the sensing signal processor 800.

The sensing signal processor 800 processes (e.g., amplifies and filters) the read sensor data signals and converts the analog sensor data signals into digital sensor data signals DSN to be sent to an external device (not shown) in response to the sensor data control signals CONT4. The external device processes these digital sensor data signals form the sensing signal processor 800 to determine whether and where a touch exists. The external device sends image signals generated based on the touch information back to the LCD.

The sensing operation may be performed independent of the display operation. The sensing operation repeats in one or several horizontal periods depending on the concentration of the sensing units. The sensing operation may not be performed every frame, but may be performed every two or more frames.

The arrangement of pixels and sensing units of an LCD according to embodiments of the present invention will be described in detail below with reference to FIGS. 6-8.

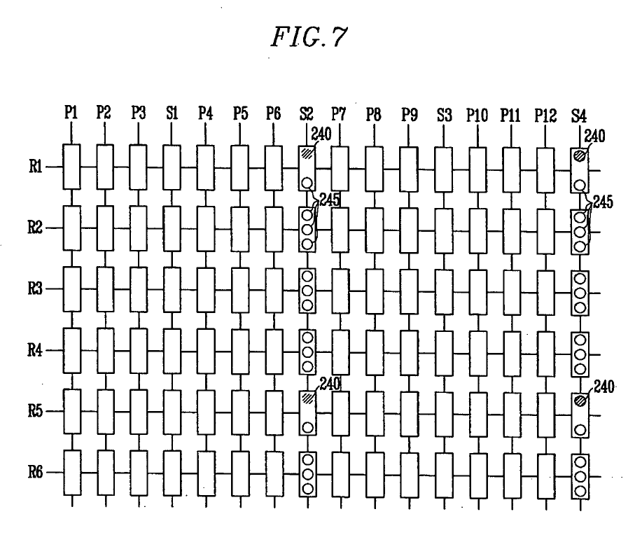

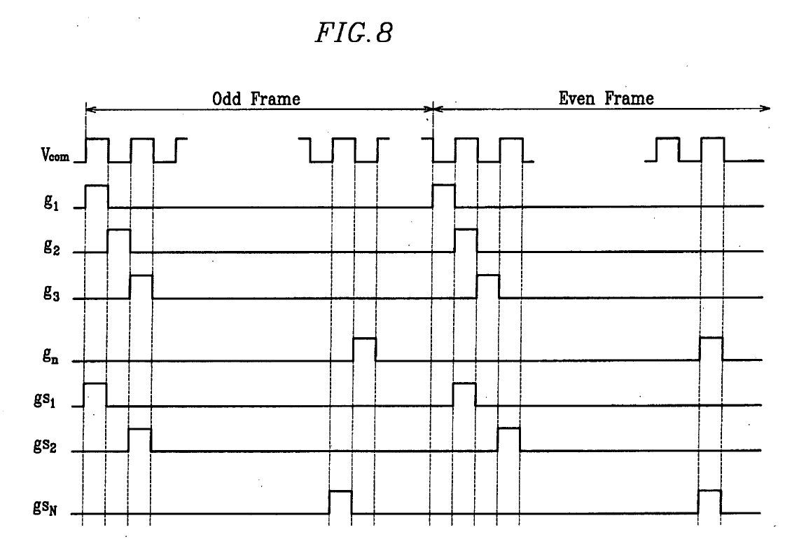

FIG. 6 illustrates an arrangement of pixels and sensing units of an LCD according to an embodiment of the present invention, FIG. 7 illustrates an arrangement of pixels and sensing units of an LCD according to another embodiment of the present invention, and FIG. 8 illustrates exemplary waveforms of a common voltage and scanning signals according to an embodiment of the present invention.

FIG. 6 shows pixels including sensing units.

Referring to FIG. 6, a pixel (represented as a rectangle) is assigned to an intersection of a row and a column. An intersection of the i-th row and the j-th column is denoted as (Rᵢ, Cⱼ).

A dot, which is a basic unit for representing a color, includes a set of three pixels, e.g., red, green, and blue pixels. These three pixels may be arranged in a row.

The photo sensing units may have a resolution that is approximately a quarter of a resolution of the LCD. For example, an LCD having a resolution of 240×320 QVGA (quarter video graphics array) includes photo sensing units having a resolution of 120×160 QQVGA (quarter QVGA). Such an LCD can be used in a precision application such as character recognition. In other embodiments, the resolution of the photo sensing units may be higher or lower.

The pressure sensing units may have a resolution equal to or lower than that of the photo sensing units. The pressure sensing units may be included in the pixels having no photo sensing unit. When the resolutions of the photo sensing units and the pressure sensing units are equal to each other, the photo sensing units and the pressure sensing units may be alternately arranged in the column direction. For example, when the photo sensing units are disposed in odd columns, the pressure sensing units are disposed in even columns. In particular, the photo sensing units may be disposed at the intersections (R1, C2), (R1, C8), (R1, C14), . . . , (R3, C2), (R3, C8), (R3, C14), . . . , (R5, C2), (R5, C8), (R5, C14), and so on, and the pressure sensing units may be disposed at the intersections (R1, C5), (R1, C11), . . . , (R3, C5), (R3, C11), . . . , (R5, C5), (R5, C11), and so on. In other embodiments, the positions of the photo sensing units and the pressure sensing units may vary.

According to an embodiment of the present invention, two or three pixels in a dot may include respective photo sensing units having commonly connected outputs. For example, sensor data lines connected to the photo sensing units are connected to each other. This configuration may reduce the variation of the characteristics of the photo sensing units and the interference caused by the image data signals of image data lines. In this case, the two or three photo sensing units may be treated as a single photo sensing unit when the resolution of the photo sensing units is calculated. In other words, the resolution of the photo sensing units depends on the number of output sensor data signals rather than the number of the photo sensing units themselves.

According to another embodiment of the present invention, two pixels in adjacent dots in the column direction may include photo sensing units simultaneously outputting sensor output signals. For example, sensor scanning lines connected to the photo sensing units are connected to each other. Then, output signals of the two photo sensing units are joined in a sensor data line. This configuration may generate a sensor data signal having a doubled signal-to-noise ratio to contain more precise touch information. In addition, this configuration may reduce the variation of the characteristics of the photo sensing units. For the latter case, the timing of a common voltage Vcom and scanning signals will be described in detail with reference to FIG. 8.

Referring to FIG. 8, the common voltage Vcom swings between a high level and a low level in a period of 2H and the waveform of the common voltage Vcom is inverted every frame.

The image scanning signals g₁-gₙ sequentially control a gate-on voltage Von having a duration of 1H to be applied to the image scanning lines G₁-Gₙ.

The sensor scanning signals gs₁-gs_{N} are synchronized with the odd image scanning signals g₂ₖ₋₁ to control the gate-on voltage Von in the odd frames, while they are synchronized with the even image scanning signals g₂ₖ to control the gate-on voltage Von in the even frames. Then, all the sensing units perform sensing operations when the common voltage Vcom is in the high level. As a result, the sensing units operate under a uniform interference caused by the common voltage Vcom, thereby reducing the distortion of the sensor data signals. In contrast, all the sensing units may operate when the common voltage Vcom is in the low level to reduce the signal distortion.

FIG. 7 shows sensing units disposed separately from the image pixels.

Referring to FIG. 7, pixels and sensing units are exclusively arranged to form respective columns. An intersection of the i-th row and the j-th pixel column is denoted as (Rᵢ, Pⱼ), and an intersection of the i-th row and the j-th sensing unit column (referred to as “sensor column” hereinafter) is denoted as (Rᵢ, Sⱼ).

A single dot includes a set of three pixels arranged in a row and a sensing unit adjacent to the pixels.

The photo sensing units may have a resolution that is a quarter of a resolution of the LCD and the pressure sensing units may have a resolution equal to or lower than that of the photo sensing units. One of two adjacent sensor columns includes the photo sensing units, while the other includes the pressure sensing units. For example, the photo sensing units are disposed in odd sensor columns, and the pressure sensing units are disposed in even columns. In particular, when the resolution of the pressure sensing units is half of that of the photo sensing units, the photo sensing units may be disposed at the intersections (R1, S1), (R1, S3), . . . , (R3, S1), (R3, S3), . . . , (R5, S1), (R5, S3), and so on, and the pressure sensing units may be disposed at (R1, S2), (R1, S4), . . . , (R5, S2), (R5, S4), and so on. In other embodiments, the positions of the photo sensing units and the pressure sensing units may vary.

FIG. 7 shows a plurality of risings 240 and a plurality of column spacers 245 in the sensor columns S2, S4, etc., which include the pressure sensing units. Three column spacers 245 are disposed at each of the intersections with no pressure sensing unit, and one column spacer 245 is disposed at each of the intersections with the pressure sensing units. However, the number of the column spacers 245 at one intersection may be changed, and the column spacers 245 may be disposed in the sensor columns S1, S3, etc., which include the photo sensing units.

Every intersection in the sensor columns that include the photo sensing units may include a photo sensing unit and a sensor scanning line is connected to the photo sensing units in two adjacent rows such that the outputs of two photo sensing units adjacent in the column direction are joined to form a single sensor data signal. In this case, the common voltage Vcom and the sensor scanning signals shown in FIG. 8 may be applied this configuration.

As described above, the arrangements of the photo sensing units and the pressure sensing units can provide precise touch information regarding the existence and the position of a touch.

Although preferred embodiments of the present invention have been described in detail hereinabove, it should be clearly understood that many variations and/or modifications will still fall within the spirit and scope of the present invention, as defined in the claims.

What is claimed is:

1. A display device comprising:
a display panel unit;
a first sensor formed on the display panel unit and generating a first sensing signal based on an external light; and
a second sensor formed on the display panel unit and generating a second sensing signal in response to a touch.

2. The display device of claim 1, wherein the first sensor comprises a switch connectable to a predetermined voltage in response to the touch.

3. The display device of claim 2, wherein the switch connects to the predetermined voltage in response to pressure exerted by the touch.

4. The display device of claim 3, wherein the switch comprises a first electrode and a second electrode spaced apart from the first electrode and connected to the predetermined voltage, wherein the second electrode and the first electrode form an electrical connection in response to a pressure applied to the second sensor.

5. The display device of claim 1, wherein the display panel unit comprises a first panel and a second panel facing the first panel and spaced apart from the first panel, wherein a distance between the first panel and the second panel is varied by a pressure exerted on the second panel.

6. The display device of claim 5, wherein the first sensor comprises a first sensing electrode disposed on the first panel and a second sensing electrode disposed on the second panel.

7. The display device of claim 6, wherein the display panel unit further comprises a liquid crystal layer disposed between the first panel and the second panel.

8. The display device of claim 7, wherein the display panel unit further comprises a first display electrode disposed on the first panel and a second display electrode disposed on the second panel.

9. The display device of claim 8, wherein the second sensing electrode is electrically connected to the second display electrode and the second sensing electrode and the second display electrode are formed in a continuous plane.

10. The display device of claim 9, wherein a distance between the first sensing electrode and the second sensing electrode is less than a distance between the first display electrode and the second display electrode.

11. The display device of claim 10, wherein the second sensing electrode and the first sensing electrode form an electrical connection in response to a pressure exerted on the second panel.

12. The display device of claim 10, wherein the second panel further comprises a rising disposed under the second sensing electrode and facing the first display electrode.

13. The display device of claim 12, wherein the distance between the first sensing electrode and the second sensing electrode is from about 0.1 microns to about 1.0 microns.

14. The display device of claim 12, wherein the display panel unit further comprises a spacer disposed between the first panel and the second panel.

15. A display device for detecting a touch, comprising:
a display panel;
a first sensor formed on the display panel and sensing a first physical quantity; and
a second sensor formed on the display panel and sensing a second physical quantity different from the first physical quantity,
wherein a touch on the display panel varies the first and the second physical quantities.

16. The display device of claim 15, wherein the touch causes a variation of the first physical quantity over a larger area than a variation of the second physical quantity caused by the touch.

17. The display device of claim 16, wherein the second physical quantity comprises luminance of light.

18. The display device of claim 17, wherein the first physical quantity comprises pressure.

19. The display device of claim 15, wherein the first sensor comprises a switch generating a bistate output signal in response to the variation of the second physical quantity.

20. The display device of claim 19, wherein the second sensor generates an indication signal having a magnitude that depends on a magnitude of the second physical quantity.

21. The display device of claim 20, wherein the second physical quantity is more sensitive than the first physical quantity to a stimulus other than a touch.

22. A display device comprising:
a display panel unit;
a plurality of first sensors formed on the display panel unit and generating first sensing signals based on an external light; and
a plurality of second sensors formed on the display panel unit and generating second sensing signals in response to a touch.

23. The display device of claim 22, wherein each of the second sensors comprises a switch connectable to a predetermined voltage in response to the touch.

24. The display device of claim 23, wherein the switch connectable to the predetermined voltage in response to pressure exerted by the touch.

25. The display device of claim 24, wherein each of the second sensor comprises a first electrode and a second electrode spaced apart from the first electrode and connected to the predetermined voltage, wherein the second electrode and the first electrode form an electrical connection in response to a pressure applied to the second sensor.

26. The display device of claim 22, wherein the second sensors have a resolution less than a resolution of the first sensors.

27. The display device of claim 26, further comprising a plurality of pixels displaying images, wherein the resolution of the first sensors is about one quarter of a resolution of the pixels.

28. The display device of claim 22, wherein at least two of the second sensors have commonly connected outputs.

29. The display device of claim 28, wherein the at least two of the second sensors simultaneously output the second sensing signals.

30. The display device of claim 22, further comprising:
a plurality of first sensor data lines, each first sensor data line being connected to a respective output of one of the first sensors; and
a plurality of second sensor data lines, each second sensor data line being connected to a respective output of one of the second sensors and arranged alternately with the first sensor data lines.

31. The display device of claim 30, wherein at least two of the second sensor data lines are connected to each other.

32. The display device of claim 31, further comprising a plurality of sensor scanning lines connected to the second sensor units and transmitting signals that cause the second sensors to output the second sensing signals.

33. The display device of claim 32, wherein at least two of the sensor scanning lines are connected to each other.

34. The display device of claim 33, further comprising a plurality of pixels formed on the display panel for displaying images.

35. The display device of claim 34, wherein the pixels are supplied with a common voltage and the second sensors are supplied with the common voltage in response to the touch.

36. The display device of claim 35, wherein the common voltage swings between first and second levels and the first and the second sensors output the second sensing signals when the common voltage has the first level.

37. The display device of claim 34, wherein the first sensors and the second sensors are disposed outside of the pixels.
